(19) United States
(12) Patent Application Publication
(10) Pub. No.: US 2008/0156339 A1
(43) Pub. Date: Jul. 3, 2008

(54) DEVICE FOR APPLYING COSMETIC PRODUCTS OR THE LIKE TO HAIR

(75) Inventor: Werner MOOSMANN, Tennenbronn (DE)

Correspondence Address: BURR & BROWN, PO BOX 7068, SYRACUSE, NY, 13261-7068, US

(73) Assignee: bomo trendline Innovative Cosmetic GmbH, Tennenbronn (DE)

(21) Appl. No.: 11/966,061

(22) Filed: Dec. 28, 2007

(30) Foreign Application Priority Data
Dec. 29, 2006 (DE) 20 2006 019 721.4

(51) Int. Cl. A45D 24/22; A45D 40/26; B05C 21/00; B05C 11/00

(52) U.S. Cl. 132/116; 132/320; 132/112; 401/196; 401/266

(57) ABSTRACT

The present invention relates to a device for applying cosmetic products or the like to hair. The device includes a pen-like housing and an applicator that includes a comb-like structure. The device is distinguished in that application means are arranged between the prongs of the comb-like structure and in the longitudinal direction of the comb-like structure.

### CROSS REFERENCE TO RELATED APPLICATION

This application claims priority from German Application No. 20 2006 019 721.4, filed Dec. 29, 2006, the entirety of which is incorporated herein by reference.

### FIELD OF THE INVENTION

The present invention relates to a device for applying cosmetic products or the like to hair.

### BACKGROUND OF THE INVENTION

EP 0 479 320 A1 discloses a device for applying liquid hair cosmetics, in particular colorants, drying preparations, hair-waving preparations, hair-treatment preparations and the like. This device is suitable for treating large areas of hair, in particular for treating hair on the head.

A second such device for treating large areas of hair on the head is known, for example, from FR 2 728 767.

### SUMMARY OF THE INVENTION

Taking as departure point the prior art which was explained in the introduction, the object of the present invention is to propose a device which is intended for applying cosmetic products or the like to hair and is well-suited for treating preferably small areas of hair, in some cases growing in an exposed position.

Accordingly, the present invention relates to a device for applying cosmetic products or the like, comprising a pen-like housing and an applicator which comprises a comb-like structure. The device is distinguished in that application means for applying the cosmetic products or the like are arranged between the prongs of the comb-like structure and in the longitudinal direction of the comb-like structure. The pen-like housing here allows precise manual guidance of the device in relation to the small area of hair which is to be treated. Arranging the application means according to the invention between the prongs of the comb-like structure thus makes it possible to grip, guide and treat individual hairs, e.g. eyebrow hairs, beard hairs, hairs of sideburns and the like. It is possible here, in addition to the treatment provided by the application of the product, for the individual hairs simultaneously to be placed, and possibly fixed, in position.

A pen-like housing is predominantly understood to be an elongate, easy-to-handle housing with the applicator provided in its end region. In a preferred embodiment, the comb-like structure of this applicator is oriented essentially in the longitudinal direction of the housing. The hair-treatment device can thus be guided in the direction of its longitudinal axis onto the hair surface which is to be treated and beyond the same, in which case, in addition to product being applied, corresponding very precise positioning of the hair, for example guided by the wrist, can take place at the same time.

In an embodiment which differs from this, it is also possible, however, for the applicator to be oriented obliquely or transversely to the longitudinal axis of the housing, but preferably, once again, at one end or a tip of the associated housing. The precise guidance via the wrist during the hair treatment, as has been explained above, also applies to these embodiments.

It is particularly preferred if the prongs project, at least in part, beyond the application means, in particular in the longitudinal direction thereof. This allows straightforward gripping and reliable guidance of the hair which is to be treated, e.g. colored or tinted, with the hair simultaneously being placed in the desired position. This can be assisted, in addition, by the prongs also projecting laterally, at least in part, beyond the application means. This allows a hair-guiding action which is initiated by way of the tips to be performed and continued as the device is moved in circular fashion for hair treatment. It is thus advantageously possible, via a correspondingly long contact region between the hair which is to be treated and the application means of the applicator, for hair to be placed permanently in the desired position at the same time.

In particular it is preferred here if the application means run upward from the starting region of the prongs, that is to say if they are located, as it were, in the region of the roots of the prongs. The application means are thus arranged centrally, in which case the hair which is to be treated is able to come into contact therewith to good effect, but the application means themselves cannot come into contact with anything, and also cannot have anything coming into contact with them, other than hair which is guided deliberately, in the envisaged manner, through the prongs. This provides, on the one hand, protection for the application means against damage and, on the other hand, protection for the user, or for other objects, against contact with the hair-treatment preparation which is to be applied by the applicator.

It is considered to be further advantageous for good transfer of the hair-treatment product to the hair which is to be treated if the application means have a rounded contour and thus assist a constant and uniform application of product to the hair which is to be treated. In order to allow the hair-treatment preparation to be supplied predominantly uniformly to the hair which is to be treated, the application means may also have an absorbent, in particular sponge-like structure. This allows a replenishing flow of hair-treatment preparation from the interior of the application means onto the outer application surface. In particular this takes place independently by way of a capillary function of the elements involved.

This can take place particularly preferably from a product reservoir which is advantageously accommodated in the housing. Such a product reservoir may be designed, for example, as a volume which can be filled once during production, as a refillable volume, as an exchangeable cartridge, as a refillable cartridge or the like. It is possible for treatment preparation to flow from the product reservoir, e.g. by capillary action, to the application means and preferably for treatment preparation in the application means to flow, likewise by capillary forces, to the surface of the application means.

In order further to optimize the handling capability for the treatment of small and/or exposed areas of hair, in particular for very short hair, as is the case with eyebrows, eyelashes, beard hairs, hairs of sideburns and the like, the prongs of the comb-like structure preferably have a height H of < approximately 5 mm.

It is also advantageous if the prongs of the comb-like structure, between their tips and the application means, have a free height of h<approximately 2 mm, in particular approximately 1 mm. It is then possible to use the device according to the invention to carry out quite precise treatment of a few, or even of individual, hairs which are to be treated in a quite precisely defined, small surface area.

It is also advantageous here if, as seen in the combing direction, the prongs are designed to be flat, in particular blade-like, in which case they allow particularly good guidance of even individual hairs in each case between the prongs.

In an advantageous embodiment, the comb-like structure here may have precisely one row of prongs. This makes it possible to realize a symmetrical construction for the device, which also allows the device to be turned during treatment. It is thus possible, perhaps if the replenishing flow of treatment preparation to the application surface of the application means is too weak, for one side and then the other side of the application means to be brought into contact with the hair which is to be treated. It is thus possible, in the interim, for a replenishing flow of treatment preparation to reach, by way of capillary action, that side of the application means which is not in use, and then to be available for further application.

A treatment operation, e.g. coloring operation, can be intensified by a slight pressure, or by an increase in the pressure, being applied to the hair which is to be treated, the therefore more pronounced “discharge” of the application means preferably likewise enhancing a replenishing-flow effect on account of capillary properties.

An approximately sugarloaf-like structure has been found to be a particularly advantageous cross-sectional shape for the comb-like structure. The tip region, which is flatly rounded as a result, provides a relatively large application surface for the hair which is to be treated, and this surface merges, beyond the rounded edge region, into a further, likewise large-surface-area and thus very effective application region.

A further preferred embodiment is defined in that the number of prongs in the comb-like structure is < approximately 15, in particular between three and eight prongs. This small number of prongs in the comb-like structure allows even extremely small areas of hair to be treated straightforwardly and precisely with the desired hair-treatment preparation. If desired, it is possible for directly adjacent areas of hair to be reliably excluded from this hair treatment and thus for a clean, precise separation line to be defined between treated and untreated hair.

In a further preferred embodiment, a number of approximately five prongs with interspaces located therebetween is provided over a length of 6 mm of the comb-like structure.

### BRIEF DESCRIPTION OF THE DRAWINGS

An embodiment of the present invention is described in more detail hereinbelow with reference to the accompanying figures, in which:

FIGS. 1 to 5 show, by way of example, different perspective views of a device for applying cosmetic products or the like to hair.

### DETAILED DESCRIPTION OF THE DRAWINGS

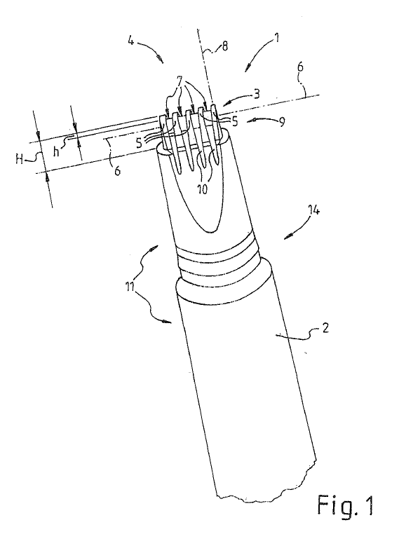

Accordingly, FIG. 1 shows, by way of example, a plan view of a device 1 for applying cosmetic products or the like to hair. This device comprises a housing 2, a comb-like structure 4 and an application means 7 which is arranged in the longitudinal direction of the comb-like structure and between the prongs 5 of the latter, as seen transversely to the longitudinal direction of the comb-like structure 4.

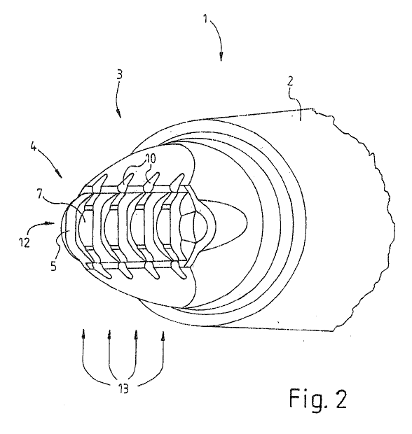

The prongs 5 here project beyond the application means 7, to be precise both in the longitudinal direction 8 thereof and laterally, as can better be seen in FIGS. 2 to 4.

The application means 7 run upward from the starting region 9 in the direction of their tips, but always remain within the envelope formed by the comb-like structure 4. This arrangement of the application means 7 in the so-called root region of the prongs 5 of the comb-like structure 4 means that, on the one hand, the application means can be largely protected against undesirable damage and, on the other hand, the hair-treatment product which is to be applied can only be discharged by these application means to matter which extends through between the prongs, normally the hair. This construction thus realizes both protection for the device and means of protecting the user and other objects against soiling.

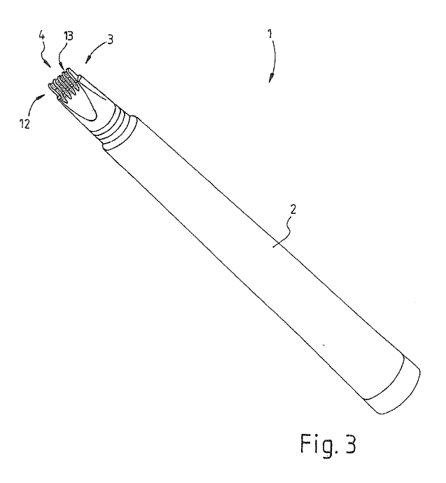

The rounded contour of the application means 7 can be seen to particularly good effect from the illustrations in FIGS. 2 and 3. The application means 7 itself has an absorbent and in particular sponge-like structure which, in the interior of the housing 2, is in product-conducting connection with an appropriately designed product reservoir 11 (not shown).

Since the prongs 5 of the comb-like structure 4 have a height H of < approximately 5 mm, but in particular < approximately 3 mm, and a free height h between their tips and the application means 7 of < approximately 2 mm, in particular approximately 1 mm, it is possible for the device to be guided precisely in order to treat individual, quite specifically selected hairs, e.g. eyebrow hairs, beard hairs, eyelashes, hairs of sideburns or the like.

The formation of an approximately sugarloaf-like structure in the cross section of the prongs, as seen in the longitudinal direction of the comb-like structure, allows neat and precise guidance of the hair which is to be treated, in particular by virtue of the device being guided from the wrist. It is possible here beginning with the comparatively large-surface-area tip, on account of the rounded contour of the application means 7, to initiate contact with the hair which is to be treated and, by a pivoting movement about the tip of the device and guidance in the longitudinal direction, to execute additional application of product and continued positioning of the hair along the longitudinal side of the applicator 3 on the basis of a natural hand movement.

The approximately sugarloaf-like structure of the prongs 5, as seen in cross section in relation to the longitudinal direction of the comb-like structure 4, and basically also the same structure of the application means 7, can best be seen in FIGS. 2, 4 and 5.

FIG. 2 shows an oblique plan view of the tip of the device according to the invention, and FIG. 3 shows an overall illustration, by way of example, of a device according to the invention.

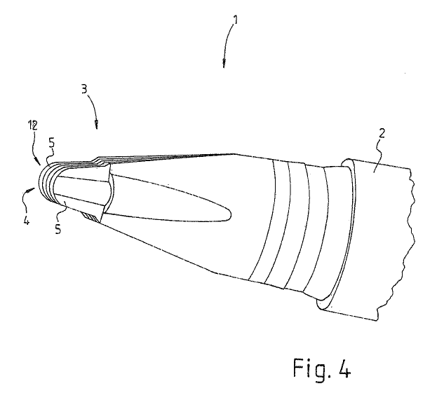

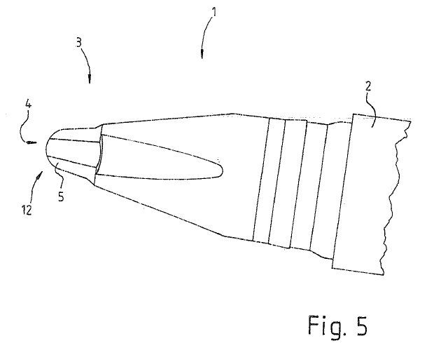

FIGS. 4 and 5, in turn, show two views of the tip of the applicator 3. FIG. 4 is a side view shown slightly obliquely from the front, in which case it is possible to see the five prongs. FIG. 5, in contrast, is a precisely aligned side view, in order to depict the sugarloaf-like cross-sectional shape of the prongs 5.

In order for it to be possible to subject extremely small areas of hair to treatment, the comb-like structure has just a single row 12 of prongs, and this row, for its part, is provided, in turn, with a small number of prongs. In the exemplary embodiment illustrated here, five prongs are provided, and these extend approximately over a length of 6 mm. The interspaces formed between the prongs 5 are designated, by way of example, by 13 in FIGS. 2 and 3.

In order to protect the device 1, it is also possible to provide a closure cap (not illustrated), and an arresting means 14 in the form of an encircling recess in the housing 2 is provided for the purpose of fastening the cap.

### LIST OF DESIGNATIONS

1 device
2 housing
3 applicator
4 comb-like structure
5 prongs
6 longitudinal direction
7 application means
8 longitudinal direction
9 starting region
10 groove
11 reservoir
12 row of prongs
13 interspace
14 arresting means

I claim:

1. A device for applying cosmetic products or the like to hair, comprising a pen-like housing and an applicator which comprises a comb-like structure, wherein application means are arranged between prongs of the comb-like structure and in the longitudinal direction of the comb-like structure.

2. The device as claimed in claim 1, wherein the prongs project, at least in part, beyond the application means, in particular in the longitudinal direction thereof.

3. The device as claimed in claim 1, wherein the prongs project laterally, at least in part, beyond the application means.

4. The device as claimed in claim 1, wherein the application means run upward from the starting region of the prongs.

5. The device as claimed in claim 1, wherein the application means have a rounded contour.

6. The device as claimed in claim 1, wherein the application means have an absorbent, in particular sponge-like structure.

7. The device as claimed in claim 1, wherein the application means are connected to a product reservoir.

8. The device as claimed in claim 1, wherein the prongs of the comb-like structure have a height (H) of less than approximately 5 mm, in particular less than approximately 3 mm.

9. The device as claimed in claim 1, wherein the prongs of the comb-like structure, between their tips and the application means, have a free height (h) of less than approximately 2 mm, in particular approximately 1 mm.

10. The device as claimed in claim 1, wherein, as seen in the longitudinal direction of the comb-like structure, the prongs have an approximately sugarloaf-like structure in cross section.

11. The device as claimed in claim 1, wherein, as seen in the combing direction, the prongs are designed to be flat, in particular blade-like, so that individual hairs can be guided between the prongs.

12. The device as claimed in claim 1, wherein the comb-like structure has precisely one row of prongs.

13. The device as claimed in claim 1, wherein the number of prongs in the comb-like structure is less than approximately 15, and in particular between approximately 3 and 8.

14. The device as claimed in claim 1, wherein approximately 5 prongs with interspaces are provided over a length of approximately 6 mm of the comb-like structure.
